(19) United States
(12) Patent Application Publication
(10) Pub. No.: US 2010/0217591 A1
(43) Pub. Date: Aug. 26, 2010

(54) VOWEL RECOGNITION SYSTEM AND METHOD IN SPEECH TO TEXT APPLICTIONS

(76) Inventor: Avraham Shpigel, Rishon Lezion (IL)

Correspondence Address: Avraham Shpigel, 5 Hahadarim str, Rishon Lezion, 75205, IL

(21) Appl. No.: 12/448,281

(22) PCT Filed: Jan. 8, 2008
(86) PCT No.: PCT/IL2008/000037

§ 371 Date: Jun. 16, 2009

Related U.S. Application Data
(60) Provisional application No. 60/879,347, filed on Jan. 9, 2007.
(60) Provisional application No. 60/906,810, filed on Mar. 14, 2007.

(51) Int. Cl. G10L 15/00; G10L 15/26

(52) U.S. Cl. 704/235; 704/251; 704/270; 704/E15.026; 704/E15.043

(57) ABSTRACT

The present invention provides systems, software and methods method for accurate vowel detection in speech to text conversion, the method including the steps of applying a voice recognition algorithm to a first user speech input so as to detect known words and residual undetected words; and detecting at least one undetected vowel from the residual undetected words by applying a user-fitted vowel recognition algorithm to vowels from the known words so as to accurately detect the vowels in the undetected words in the speech input, to enhance conversion of voice to text.

### REFERENCE TO PREVIOUS APPLICATIONS

This application claims priority from U.S. Provisional Patent Application 60/879,347 filed Jan. 9, 2007, entitled “Vowels Recognition Method for Spontaneous User Speech” and from U.S. Provisional Patent Application 60/906,810 filed on Mar. 14, 2007, entitled “LVCSR Client/Server Architecture for Transcription Applications” both to Abraham Shpigel, the contents of which are incorporated herein in their entirety.

### FIELD OF THE INVENTION

The present invention relates generally to speech to text systems and methods, and more specifically to automated systems and methods for enhancing speech to text systems and methods over a public communication network.

### BACKGROUND OF THE INVENTION

Automatic speech-to-text conversion is a useful tool which has been applied to many diverse areas, such as Interactive Voice Response (IVR) systems, dictation systems and in systems for the training of or the communication with the hearing impaired. The replacement of live speech with written text may often provide a financial saving in communication media where the reduction of time required for delivery of transmission and the price of transmission required thereof is significantly reduced. Additionally, speech-to-text conversion is also beneficial in interpersonal communication since reading written text may be up to ten times faster than speech of the same.

Like many implementations of signal processing, speech recognition of all sorts is prone to difficulties such as noise and distortion of signals, which leads to the need of complex and cumbersome software coupled with suitable electrical circuitry in order to optimize the conversion of audio signals into known words.

In recent years, there have been numerous implementations of speech-to-text algorithms in various methods and systems. Due to the nature of audio input, the ability to handle unidentified words is crucial for the efficacy of such systems. Two methods for dealing with unrecognized words according to prior art include asking the speaker to repeat the unrecognized utterances or finding a word which may be considered as the closest, even if it is not the exact word. However, while the first method is time consuming and may be applied only when the speech-to-text conversion is performed in real-time, the second method may yield unexpected results which may alter the meaning of the given sentences.

There is therefore a need to provide improved speech to text methods and systems. Some developments in this field appear in the following publications:

U.S. Pat. No. 6,289,305 to Kaja, describes a method for analyzing speech involving detecting the formants by division into time frames using linear prediction.

U.S. Pat. No. 6,236,963, to Naito et al, describes a speaker normalization processor apparatus with a vocal-tract configuration estimator, which estimates feature quantities of a vocal-tract configuration showing an anatomical configuration of a vocal tract of each normalization-target speaker, by looking up to a correspondence between vocal-tract configuration parameters and Formant frequencies previously determined based on a vocal tract model of the standard speaker, based on speech waveform data of each normalization-target speaker. A frequency warping function generator estimates a vocal-tract area function of each normalization-target speaker by changing feature quantities of a vocal-tract configuration of the standard speaker based on the feature quantities of the vocal-tract configuration of each normalization-target speaker estimated by the estimation means and the feature quantities of the vocal-tract configuration of the standard speaker, estimating Formant frequencies of speech uttered by each normalization-target speaker based on the estimated vocal-tract area function of each normalization-target speaker, and generating a frequency warping function showing a correspondence between input speech frequencies and frequencies after frequency warping.

U.S. Pat. No. 6,708,150, to Yoshiyuki et al, discloses a speech recognition apparatus including a speech input device; a storage device that stores a recognition word indicating a pronunciation of a word to undergo speech recognition; and a speech recognition processing device that performs speech recognition processing by comparing audio data obtained through the voice input device and speech recognition data created in correspondence to the recognition word, and the storage device stores both a first recognition word corresponding to a pronunciation of an entirety of the word to undergo speech recognition and a second recognition word corresponding to a pronunciation of only a starting portion of a predetermined length of the entirety of the word to undergo speech recognition as recognition words for the word to undergo speech recognition.

U.S. Pat. No. 6,785,650 describes a method for hierarchical transcription and displaying of input speech. The disclosed method includes the ability to combine representation of high confidence recognized words with words constructed by a combination of known syllables and of phones. There is no construction of unknown words by the use of vowels anchors identification and search of adjacent consonants to complete the syllables.

Moreover, U.S. Pat. No. 6,785,650 suggests combining known syllables with phones of unrecognized syllables in the same word whereas the present invention replaces the entire unknown word by syllables leaving their interpretation to the user. By displaying partially-recognized words the method described by U.S. Pat. No. 6,785,650 obstructs the process of deciphering the text by the user since word segments are represented as complete words and are therefore spelled according to word-spelling rules and not according to syllable spelling rules.

There is therefore a need for a means for transcribing and representing unidentified words in a speech-to-text conversion algorithm in syllables.

WO06070373A2, to Shpigel, discloses a system and method for overcoming the shortcomings of existing speech-to-text systems which relates to the processing of unrecognized words. On encountering words which are not decipherable by it the preferred embodiment of the present invention analyzes the syllables which make up these words and translates them into the appropriate phonetic representations based on vowels anchors.

The method described by Shpigel ensures that words which were not uttered clearly are not be lost or distorted in the process of transcribing the text. Additionally, it allows using smaller and simpler speech-to-text applications, which are suitable for mobile devices with limited storage and processing resources, since these applications may use smaller dictionaries and may be designed only to identify commonly used words. Also disclosed are several examples for possible implementations of the described system and method.

The existing transcription engines known in the art (e.g. IBM LVCSR) have an accuracy of around only 70-80%, which is due to the quality of the phone line, the presence of spontaneous users, ambiguity of different words of the same sound of different meanings such as “to”, “too” and “two”, unknown words/names, other speech to text errors. This low accuracy leads to limited commercial applications.

The field of data mining, and more particularly speech mining or text data mining is growing rapidly. Speech-to-text and text-to-speech applications include applications that talk, which are most useful for companies seeking to automate their call centers. Additional uses are speech-enabled mobile applications, multimodal speech applications, data-mining predictions, which uncover trends and patterns in large quantities of data; and rule-based programming for applications that can be more reactive to their environments.

Speech mining can also provide alarms and is essential for intelligence and law enforcement organizations as well as improving call center operation.

Current speech-to-text conversion accuracy is around 70-80%, which means that the use of either speech mining or text mining is limited by the inherent lack of accuracy.

There is therefore an urgent need to provide systems and methods which provide more accurate speech-to-text conversion than those described to date, so that data mining applications can be used more effectively.

### SUMMARY OF THE INVENTION

It is an object of some aspects of the present invention to provide systems and methods which provide accurate speech-to-text conversion.

In preferred embodiments of the present invention, improved methods and apparatus are provided for accurate speech-to-text conversion, based on user fitted accurate vowel recognition.

In other preferred embodiments of the present invention, a method and system are described for providing speech-to-text conversion of spontaneous user speech.

In further preferred embodiments of the present invention, method and system are described for speech-to-text conversion employing vowel recognition algorithms.

There is thus provided according to an embodiment of the present invention, a method for accurate vowel detection in speech to text conversion, the method including the steps of;

applying a voice recognition algorithm to a first user speech input so as to detect known words and residual undetected words; and

detecting at least one undetected vowel from the residual undetected words by applying a user-fitted vowel recognition algorithm to vowels from the known words so as to accurately detect the vowels in the undetected words in the speech input.

According to some embodiments, the voice recognition algorithm is one of; Continuous Speech Recognition, Large Vocabulary Continuous Speech Recognition, Speech-To-Text, Spontaneous Speech Recognition and speech transcription.

According to some embodiments, the detecting vowels step includes:

creating reference vowel formants from the detected known words;

comparing vowel formants of the undetected word to reference vowel formants; and

selecting at least one closest vowel to the reference vowel so as to detect the at least one undetected vowel.

Furthermore, in accordance with some embodiments, the creating reference vowel formants step includes;

calculating vowel formants from the detected known words;

extrapolating formant curves including data points for each of the calculated vowel formants; and

selecting representative formants for each vowel along the extrapolated curve.

According to some embodiments, the extrapolating step includes performing curve fitting to the data points so as to obtain formant curves.

According to some further embodiments, the extrapolating step includes using an adaptive method to update the reference vowels formant curves for each new formant data point.

Yet further, in accordance with some embodiments, the method further includes detecting additional words from the residual undetected words.

In accordance with some additional embodiments, the detecting additional words step includes;

accurately detecting vowels of the undetected words; and

creating sequences of detected consonants combined with the accurately detected vowels;

searching at least one word database the sequence of consonants and vowels with a minimum edit distance; and

detecting at least one undetected word provided that a detection thereof has a confidence level above predefined threshold.

According to some embodiments, the method further includes creating syllables of the undetected words based on vowel anchors.

According to some additional embodiments, the method further includes collating the syllables to form new words.

Yet further, according to some embodiments, the method further includes applying phonology and orthography rules to convert the new words into correctly written words.

Additionally, according to some embodiments, the method further includes employing a spell-checker to convert the new words into detected words, provided that a detection thereof has a confidence level above predefined threshold.

According to some embodiments, the method further includes converting the user speech input into text.

Additionally, according to some embodiments, the text includes at least one of the following: detected words, syllables based on vowel anchors, and meaningless words.

According to some embodiments, the user speech input may be detected from any one or more of the following inputting sources; a microphone, a microphone in any telephone device, an online voice recording device, an offline voice repository, a recorded broadcast program, a recorded lecture, a recorded meeting, a recorded phone conversation, recorded speech, multi-user speech.

According to some embodiments, the method includes multi-user speech including applying at least one device to identify each speaker.

Yet further, in accordance with some embodiments, the method further includes relaying of the text to a second user device selected from at least one of: a cellular phone, a line phone, an IP phone, an IP/PBX phone, a computer, a personal computer, a server, a digital text depository, and a computer file.

Additionally, in accordance with some embodiments, the relaying step is performed via at least one of: a cellular network, a PSTN network, a web network, a local network, an IP network, a low bit rate cellular protocol, a CDMA variation protocol, a WAP protocol, an email, an SMS, a disk-on-key, a file transfer media or combinations thereof.

Yet further, in accordance with some embodiments, the method further includes defining search keywords to apply in a data mining application to at least one of the following: the detected words and the meaningless undetected words.

According to some embodiments, the method is for use in transcribing at least one of an online meeting through cellular handsets, an online meeting through IP/PBX phones, an online phone conversation, offline recorded speech, and other recorded speech, into text.

According to some embodiments, the method further includes converting the text back into at least one of speech and voice.

According to some additional embodiments, the method further includes pre-processing the user speech input so as to relay pre-processed frequency data in a communication link to the communication network.

According to some embodiments, the pre-processing step reduces at least one of: a bandwidth of the communication link, a communication data size, a user on-line air time; a bit rate of the communication link.

According to some embodiments, the method is applied to an application selected from: transcription in cellular telephony, transcription in IP/PBX telephony, off-line transcription of speech, call center efficient handling of incoming calls, data mining of calls at call centers, data mining of voice or sound databases at internet websites, text beeper messaging, cellular phone hand-free SMS messaging, cellular phone hand-free email, low bit rate conversation, and in assisting disabled user communication.

According to some embodiments, the detecting step includes representing a vowel as one of: a single letter representation and a double letter representation.

According to some embodiments, the creating syllables includes linking of consonant to anchor vowel as one of: tail of previous syllable or head on next syllable according to its duration.

According to some embodiments, the creating syllables includes joined successive vowels in a single syllable.

According to some embodiments, the searching step includes a different scoring method for matched vowel or match consonant in word database includes at least one of detection accuracy and time duration of consonant or vowel.

The present invention is suitable for various chat applications and for the delivery of messages, where the speech-to-text output is read by a human user, and not processed automatically, since humans have heuristic abilities which would enable them to decipher information which would otherwise be lost. It may be also used for applications such as dictation, involving manual corrections when needed.

The present invention enables overcoming the drawbacks of prior art methods and more importantly, by raising the compression factor of the human speech, it enables the reduction of transmission time needed for conversation and thus reduces risks involving exposure to cellular radiation and considerably reduces communication resources and cost.

The present invention enhances data mining applications by producing more search keywords due to 1) more accurate STT detection 2) creation of meaningless words (words not in the STT words DB). The steps include a) accurate vowel detection, b) detection of additional words using STT based on the comparing of a sequence of combined prior art detected consonants and the accurate detected vowels with DB of words arranged in sequences of consonants and vowels, c) the residual undetected words are processed with phonology-orthography rules to create correctly written words, and d) prior art speller is used to obtain additional detected words, and. then e) the remaining correctly written but unrecognized words can be used as additional new keywords e.g. ‘suzika’ is not a known name but it can be used as a search keyword in database of text like news in radio programs converted to text as proposed in this invention. More general comment, the number of nouns/names is endless so, none of the STT engines can cover all the possible names.

This invention defines methods for the detection of vowels. Vowel detection is noted to be more difficult than consonant detection because, for example, vowels between two consonants tend to change when uttered because the human vocal elements change formation in order to follow an uttered consonant. Today, most speech-to-text engines are not based on sequences of detected consonants combined with the detected vowels to detect words as proposed in this invention.

Prior art commercial STT engines are available for dictation of reading text from book/paper/news. These engines have a session called training in which the machine (PC) learns the user characteristics while saying predefined text. On the other hand, ‘spontaneous’ users relates to ‘free speaking’ style using slang words, partial words, thinking delays between syllables and the case when training session is not available. These obstacles degrade prior art STT for spontaneous users to the level of 70-80%.

A training sequence is not required in this invention but some common words must be detected by the prior art STT to obtain some reference vowels for the basis of the vowels/formats curve extrapolator. The number of English vowels is 11 (compared to 26 consonants) and each word normally contains at least one vowel. Thus, only a few common words, that are used in everyday conversation, such as numbers, prepositions, common verbs (e.g. go, take, see, move, . . . ), which are typically included at the beginning of every conversation, will be sufficient to provide a basis for reference vowels in a vowels/formants curve extrapolator.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic pictorial illustration of an interactive system for conversion of speech to text using accurate personalized vowel detection, in accordance with an embodiment of the present invention;

FIG. 2 is simplified pictorial illustration of a system for call center using data mining in a speech to text method, in accordance with an embodiment of the present invention.

FIG. 3A is a simplified pictorial illustration of a system for partitioning speech to text conversion, in accordance with an embodiment of the present invention;

FIG. 3B is a simplified pictorial illustration of a system for non-partitioned speech to text conversion, in accordance with an embodiment of the present invention;

FIG. 3C is a simplified pictorial illustration of a system for web based data mining, in accordance with an embodiment of the present invention;

FIGS. 4A-4C are spectrogram graphs of prior art experimental results for identifying vowel formants, (4A, i/green, 4B /ae/hat and 4C /u/boot), in accordance with an embodiment of the present invention,

FIG. 5 is a graph showing a prior art method for mapping vowels according to maxima of two predominant formants of each different vowel, in accordance with an embodiment of the present invention;

FIG. 6 is a graph of user sampled speech (dB) over time, in accordance with an embodiment of the present invention;

FIG. 7 is a simplified flow chart of method for converting speech to text, in accordance with an embodiment of the present invention;

FIG. 8 is a simplified flow chart of method for calculating user reference vowels based on the vowels extracted from known words, in accordance with an embodiment of the present invention;

FIG. 9A is a graphical representation of theoretical curves of formants on frequency versus vowels axes;

FIG. 9B is a graphical representation of experimentally determined values of formants on frequency versus vowels axe, in accordance with an embodiment of the present invention;

FIG. 10 is a simplified flow chart of a method for transforming spontaneous user speech to text and uses thereof, in accordance with an embodiment of the present invention;

FIG. 11 is a simplified flow chart of a method for detection of words, in accordance with an embodiment of the present invention; and

FIG. 12 is a simplified flow chart illustrating one embodiment of a method for partitioning speech to text conversion, in accordance with an embodiment of the present invention.

### DETAILED DESCRIPTION OF PREFERRED EMBODIMENTS

The present invention describes systems, methods and software for accurately converting speech to text by applying a voice recognition algorithm to a user speech input so as to calculate at least some reference vowel formants from the known detected words and then extrapolating missing vowel formants using a user-fitted vowel recognition algorithm used to convert the user speech to text.

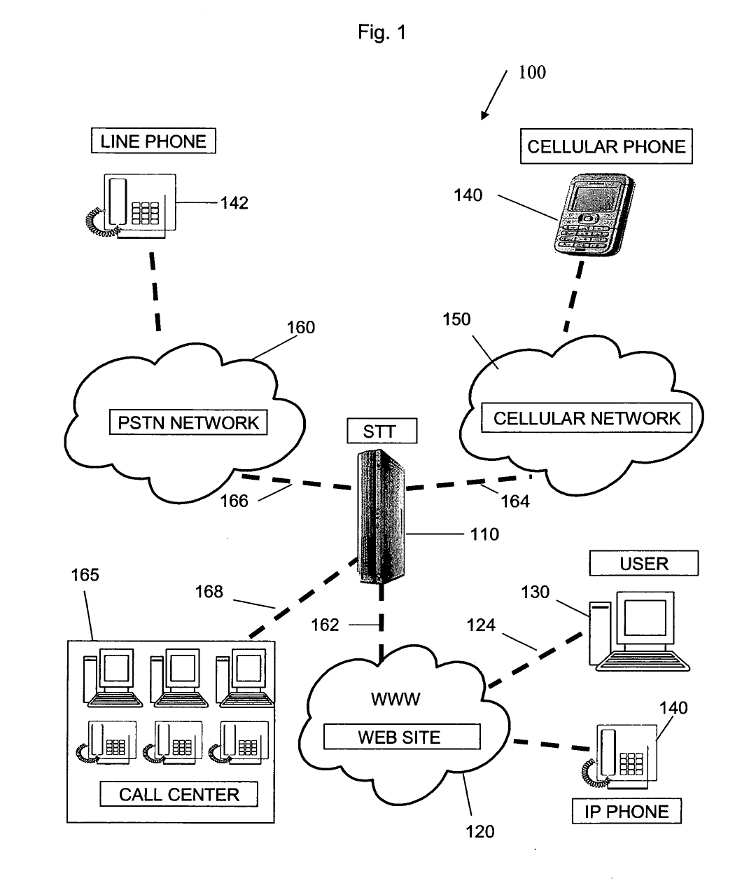

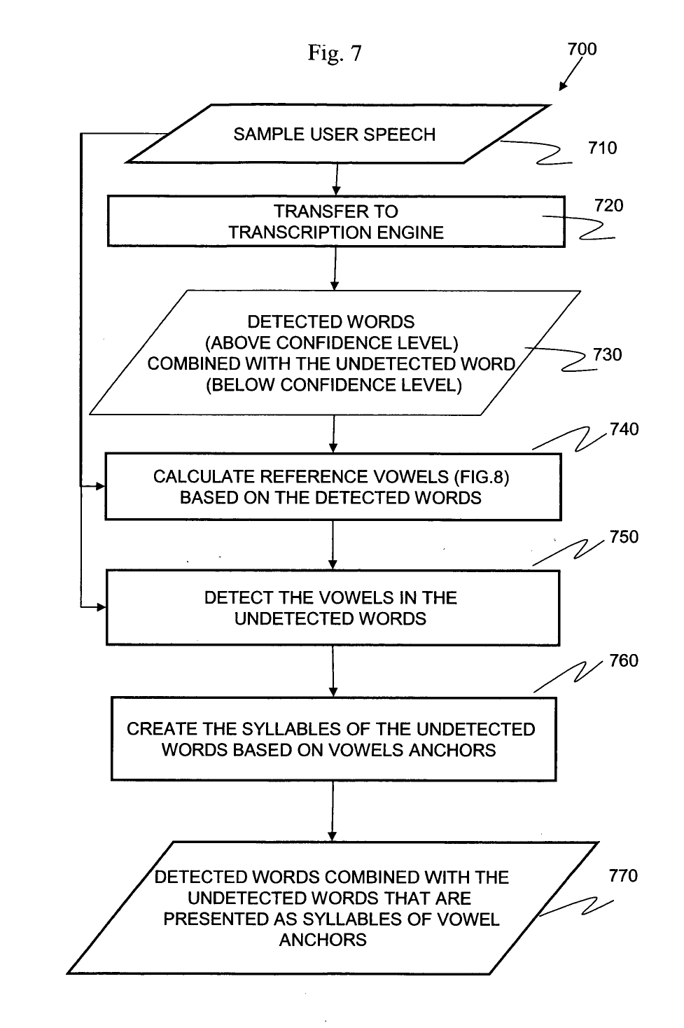

The methods of the present invention described in detail with respect to FIGS. 7-12 hereinbelow may be applied using the systems of FIGS. 1-3.

It should be understood that prior art methods of conversion of spontaneous speech-to-text have a typical accuracy of only 70-80% and thus cannot be applied to many applications. In sharp contrast, the methods of conversion of speech-to-text of the present invention have an expected much higher accuracy than the prior art methods due to the following properties:
a) the method is user-fitted and personalized for vowel detection;
b) the method provides additional word detection (beyond those of prior art methods) and is based on sequences on combined prior art detected consonants combined with accurately detected vowels;
c) the method employs contextual transliteration of syllables based on vowel anchors, which can then be recognized as words; and
d) the method provides syllables, which are based on vowel anchors for the detection of the residual undetected words, which are easy to identify and are thus easily interpreted by a human end user.

Thus the methods of the present invention may be applied to a plurality of data mining applications, as well as providing a saving, in inter alia, call time, call data size, message, message attachment size.

Some notable applications of the methods of the present invention are provided in Table 1. It should be understood that the methods of the present invention provide improved speech to text conversion due to the following method aspects (MA):
1. Improved speech to text (STT) conversion typically providing an expected increase in accuracy of 5-15% on the prior art methods.
2. Creating meaningless but correctly written words based on phonology orthography rules.
3. Residual unrecognized words (20-30%) from the prior art enhanced speech to text conversion are presented as syllables based on vowel anchors.
4. Cellular pre/post processing to reduce the computational load and memory size from the cellular handset and saves on-line air time (or reduce the communication bit rate).

TABLE 1
Uses of Invention Method Aspects (MAs) in Speech-to-Text
Applications.

| Application | Description | MAs |
|---|---|---|
| Transcription in | Online transcription via cellular phones or other | 1-4 |
| Cellular Telephony | cellular devices using pre/post processing. | |
| | Examples: transcription of meetings outside the | |
| | office e.g. coffee bar, small talk, etc. | |
| Transcription in | Online transcription via IP/PBX line phone. | 1-3 |
| IP/PBX telephony | Example: meetings in organization when phone line | |
| | is present in the meeting room | |
| Off-line transcription | Offline transcription using regular recorder and later | 1-3 |
| of speech | transcription. | |
| | Examples: students transcribing recorded lectures, | |
| | transcribing recorded discussions in court room, etc. | |
| Efficient handling | Call center incoming call, IP PBX phone incoming | 1-3 |
| Incoming calls | call and cellular handset incoming call. | |
| | Example: the calling user request is transcribed and | |
| | presented to the representative (or the called user) | |
| | before answering the call. | |
| Data mining of calls | Call center automatic data mining. | 1 |
| at call centers | More accurate (speech to text)STT for producing | |
| | more search keywords. | |
| | Note: aspect 2 is not effective because in call centers | |
| | all the search keywords are predefined. | |
| Data mining of | Internet website application. | 1-3 |
| voice/sound | Example: searching content in audio/video broadcast | |
| databases at internet | repository. | |
| websites | Note: aspect 2 is very useful because meaningless | |
| | keywords are very valuable for the search because of | |
| | the diversity and unexpected content | |
| Beeper | Leave message automatically - thus no need for | 1-2 |
| | human transcription center | |
| Cellular phone | Fluent transcription - no need to ask the user when | 1-3 |
| hands-free SMS or | a word is not known. Cellular handset is personal, | |
| email | thus the user fitted reference vowels can be saved | |
| | for the next time. | |
| Cellular low bit rate | Conversational speech converted to text and | 1-4 |
| conversation | transferred via low bit rate communication link e.g. | |
| | IP/WAP | |
| Hearing-Disabled Users | Deaf users receiving voice converted to text. | 1-3 |
| | Deaf users that can speak freely but to see the | |
| | incoming voice as text | |
| Sight-Disabled Users | Converting the incoming email or SMS text to voice. | 3 |
| | Note: the vowel anchors transcription syllables can be converted | |
| | naturally to speech again | |

The user fitted vowel recognition algorithm of the present invention is very accurate with respect to vowel identification and is typically user-fitted or personalized. This property allows more search keywords in data mining applications, typically performed by:
a) additional speech to text detection, based on sequences of consonants, combined with accurately detected vowels;
b) creating correctly written words by using phonology-orthography rules; and
c) using a spell checker to detect additional words.

Some of the resultant words may be meaningless. The meaningless words may be understood, nevertheless, due to them being transliterations of sound comprising personalized user-pronounced vowels, connected to consonants to form transliterated syllables, which in text are recognized according to their context and sounded pronunciation.

In addition, a spell-checker can be used together with the vowel recognition algorithm of the present invention to find additional meaningful words, when the edit distance between the meaningless word and an identified word is small.

Reference is now made to FIG. 1, which is a schematic pictorial illustration of a computer system 100 for conversion of speech-to-text using accurate personalized vowel detection, in accordance with an embodiment of the present invention.

It should be understood that many variations to this system are envisaged, and this embodiment should not be construed as limiting. For example, a facsimile system or a phone device (wired telephone or mobile phone) may be designed to be connectable to a computer network (e.g. the Internet). Interactive televisions may be used for inputting and receiving data from the Internet.

System 100 typically includes a server utility 110, which may include one or a plurality of servers.

Server utility 110 is linked to the Internet 120 (constituting a computer network) through link 162, is also linked to a cellular network 150 through link 164 and to a PSTN network 160 through link 166. These plurality of networks are connected one to each other via links, as is known in the art.

Users may communicate with the server 110 via a plurality of user computers 130, which may be mainframe computers with terminals that permit individual to access a network, personal computers, portable computers, small hand-held computers and other, that are linked to the Internet 120 through a plurality of links 124.

The Internet link of each of computers 130 may be direct through a landline or a wireless line, or may be indirect, for example through an intranet that is linked through an appropriate server to the Internet. The system may also operate through communication protocols between computers over the Internet which technique is known to a person versed in the art and will not be elaborated herein.

Users may also communicate with the system through portable communication devices, such as, but not limited to, 3^{rd} generation mobile phones 140, communicating with the server 110 through a cellular network 150 using plurality of communication links, such as, but not limited to, GSM or IP protocol e.g. WAP.

A user may also access the server 110 using line phone 142 connected to the PSTN network and IP based phone 140 connected to the internet 120.

As will readily be appreciated, this is a very simplified description, although the details should be clear to the artisan. Also, it should be noted that the invention is not limited to the user-associated communication devices—computers and portable and mobile communication devices—and a variety of others such as an interactive television system may also be used.

The system 100 also typically includes at least one call and/or user support center 165. The service center typically provides both on-line and off-line services to users from the at least one professional and/or at least one data mining system for automatic response and/or data mining retrieved information provided to the CSR.

The server system 110 is configured according to the invention to carry out the methods described herein for conversion of speech to text using accurate personalized vowel detection.

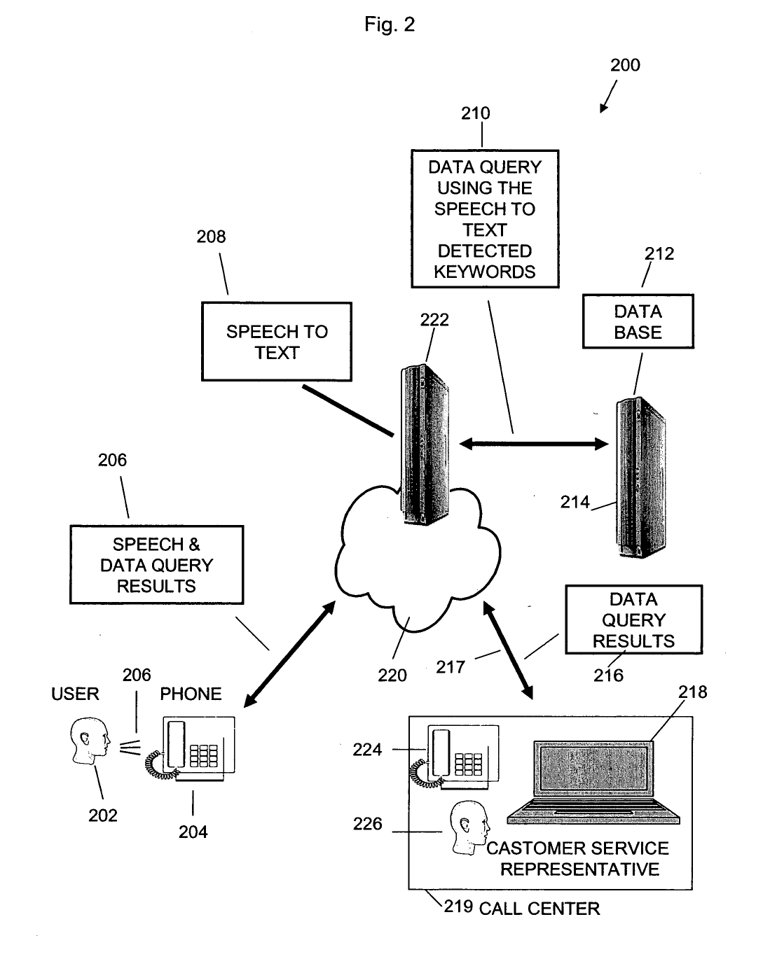

Reference is now made to FIG. 2, which is simplified pictorial illustration of a system for call center using data mining in a speech to text method, in accordance with an embodiment of the present invention.

System 200 may be part of system 100 of FIG. 1.

According to some aspects of the present invention, a user 202 uses a phone line 204 to obtain a service from a call center 219. The user's speech 206 is transferred to the STT 222, which converts the speech to text 217 using a speech to text converter 208. One output from the speech to text converter 208 may be accurately detected words 210, which may be sent to another database system 214 as a query for information relating to the user's request. System 214 has database of information 212, such as bank account data, personal history records, national registries of births and deaths, stock market and other monetary data.

According to some aspects of the present invention, the detected words or retrieved information 210 may be sent back to the user's phone 204. An example of this could be a result of a value of specific shares or a bank account status. In other aspects of the present invention, database 214 may output data query results 216, which may be sent to the call center to a customer service representative (CSR) 226, which, in turn, allows the CSR to handle the incoming call 224 more efficiently since the user relevant information e.g. bank account status is already available on the CSR screen 218 when the CSR answers the call.

In some aspects of the present invention, the spontaneous user speech 202 representing a user request is converted to text by speech to text converter 208 at server 222, where the text is presented to the call center 219 as combined detected words and the undetected words presented as syllables based on vowel anchors. In some other aspects of the present invention, the syllables can be presented as meaningless but well written words. The CSR 226 can handle the incoming call more efficiently, relative to prior art methods, because the CSR introduction time may be up to 10 times faster than a spoken request (skimming text vs speaking verbally). The server may request spoken information from the user by using standardized questions provided by well defined scenarios. The user may then provide his request or requests in a free spoken manner such that the server 222 can obtain directed information from the user 202, which can be presented to the CSR as text, before answering the user's call e.g. “yesterday I bought Sony game ‘laplaya’ in the ‘histeria’ store when I push the button name ‘dindeling’ it is not work as described in the guide . . . ”. This allows the CSR to prepare a tentative response for the user, prior to receiving his call.

In some aspects of the present invention, server 222 can be part of the call center infrastructure 219 or as a remote service to the call center 219 connected via IP network.

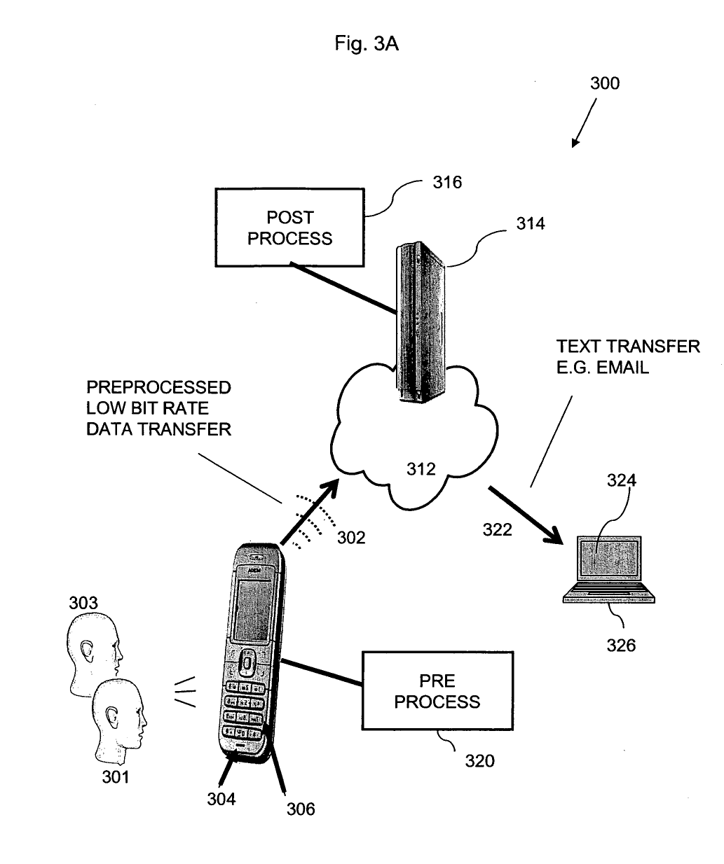

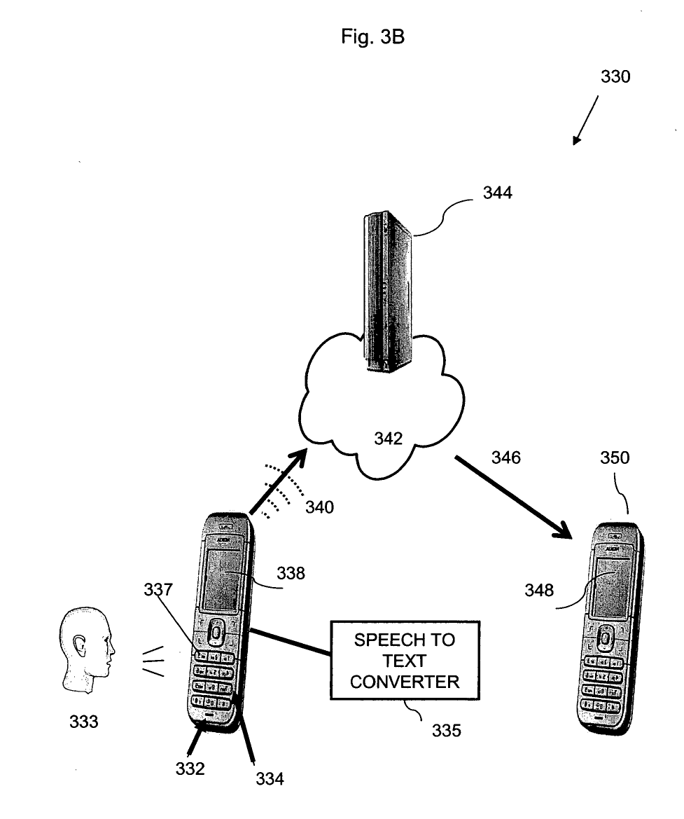

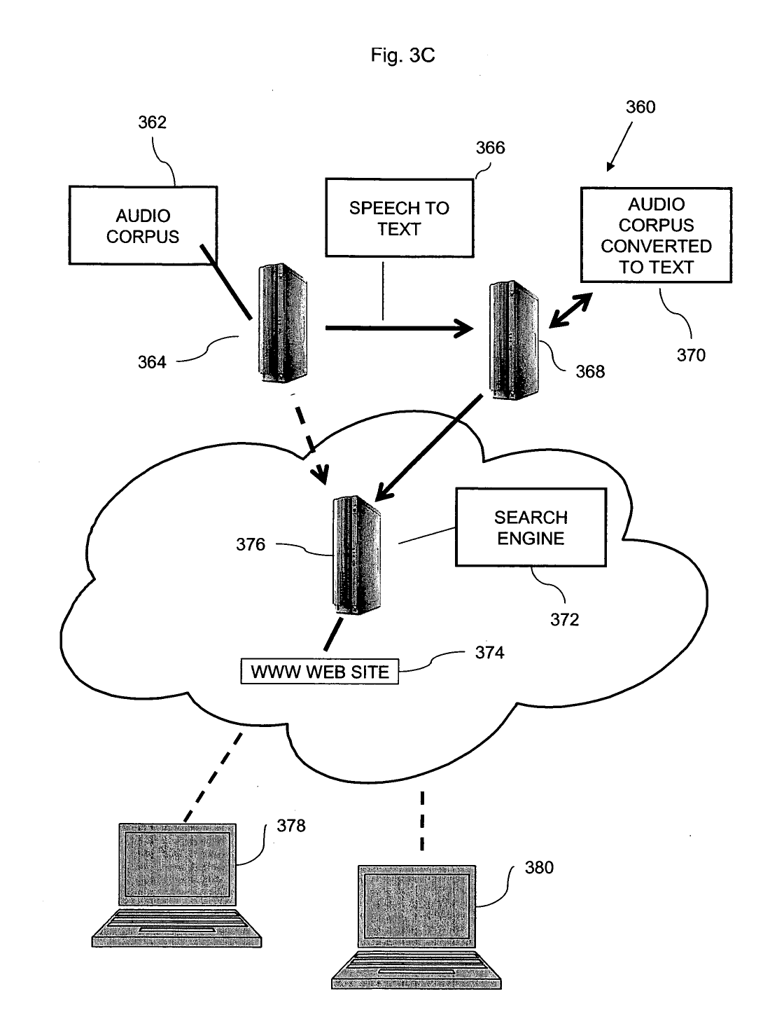

Reference is now made to FIG. 3A, which is a simplified pictorial illustration of a system 300 for partitioning speech to text conversion, in accordance with an embodiment of the present invention.

Some aspects of the present invention are directed to a method of separating LVCSR tasks between a client/sender and a server according to the following guidelines:

LVCSR client side—minimizes the computational load and memory and minimizes the client output bit rate.

LVCSR server side—completes the LVCSR transcription having the adequate memory and processing resources.

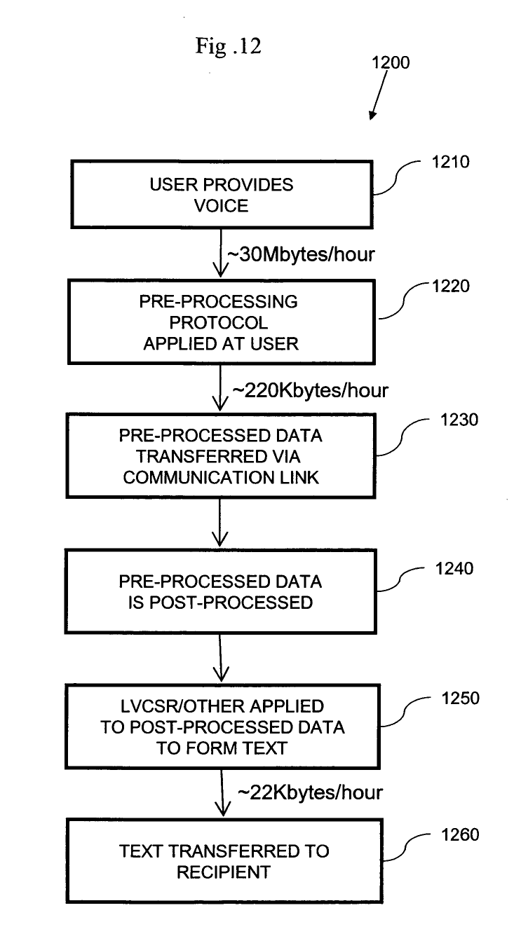

The implementation of the method of FIG. 12, described in more details hereinbelow in cellular communication, for example, is illustrated in FIG. 3A. The system comprises at least one cellular or other communication device 306, having voice preprocessing software algorithm 320, integrated therein. To make use of the functionality offered by the algorithm 320, one or more users 301, 303 verbalizes a short message, long call or other sounded communication.

Other sounded communications may include meetings recordings, lectures, speeches, songs and music. For example, during a meeting a constant flow of data is transferred to a server 314 via low bit-rate communication link 302, such as WAP, which may be recorded by a microphone 304 in the cellular device or by other means known in the art. It should be understood that the methods and systems of the present invention may be linked to a prior art voice recognition system for identifying each speaker during a multi-user session, for example, in a business meeting.

Algorithm 320 preprocesses the audio input using, for example a Fast Fourier Transform (FFT) into an output of results of processed sound frequency data or partial LVCSR outputs. The resultant output is sent to a server 314, such as on a cellular network 312 via a cellular communication route 302. At the server, the preprocessed data is post-processed using a post-processing algorithm 316 and the resultant text message is passed via a communication link 322 to a second communication device 326. When retrieved, the text appears on display 324 of a second device 326 in a text format.

According to some other embodiments, the text may also be converted back into speech by second device 326 using a text-to-speech converter mostly to known words, as well as a small proportion of sounded syllables (this is discussed in further detail with reference to FIGS. 7-12 hereinbelow).

Second device 326 may be any type of communication device or cellular device which can receive from the STT server 314 SMS messages, emails, file transfer or the like, or a public switch telephone network (PSTN) device which can display SMS messages or represent them to the user by any other means or an internet application.

Turning to FIG. 3B there can be seen another system 330 for non-partitioned speech to text conversion, in accordance with an embodiment of the present invention.

Addition of a highly accurate speech-to-text functionality enables users to vocally record short announcements and send them as standard messages in short messaging system (SMS) format. Since most cellular devices do not have full keyboards and allow users to write text messages using only the keypad, the procedure of composing text messages is cumbersome and time-consuming. Sometimes using keypad for writing SMS is against the law e.g. while driving. Speech-to-text functionality enables offering users of cellular devices a much easier and faster manner for composing text messages. However, most prior art speech-to-text applications are not particularly useful for SMS communication since SMS users tend to use many abbreviations, acronyms, slang and neologisms which are in no way standard and are therefore not part of commonly used speech-to-text libraries.

The functionality disclosed by the present invention overcomes this problem by providing the user with a phonetic representation of unidentified words. Thus, non-standard words may be used and are not lost in the transference from spoken language to the text.

The algorithm operates within a speech-to-text converter 335, which is integrated into cellular device 334. To make use of the functionality offered by the speech-to-text converter 335, user 333 pronounces a short message which is captured by microphone 332 of the cellular device 334. The Speech-to-text converter 335 transcribes the audio message into text according to the algorithm described hereinbelow. The transcribed message is then presented to the user on display 338. Optionally, the user may edit the message using keypad 337 and when satisfied user 333 sends the message using conventional SMS means to a second device 350. The message is sent to SMS server 344 on cellular network 342 via cellular communication link 340 and routed via link 346 to a second device 350. When retrieved, the message appears on display 348 of the second device in a text format. The message may also be converted back into speech by second device 344 using text-to-speech converters based on the syllables.

Second device 344 may be any type of cellular device which can receive SMS messages, a public switch telephone network (PSTN) device which can display SMS messages or represent them to the user in any other means or an internet application.

According to another embodiment of the present invention, cellular device 334 and second device 350 may establish a text communication session, which is input as voice. In the text communication session the information is transformed into text format before being sent to the other party. This means of communication is especially advantageous in narrow-band communication protocols and in communication protocols which make use of Code Division Multiple Access (CDMA) communication means. Since in CDMA the cost of the call is determined according to the volume of transmitted data, the major reduction of data volume which the conversion of audio data to textual data enables dramatically reducing the overall cost of the call. For the purpose of implementing this embodiment, the speech-to-text converter 335 may be inside each of the devices 334, 350, but may alternatively be on the server or client server side, see for example the method as described with respect to FIG. 3A.

The spoken words of each user in a text communication session are automatically transcribed according to the transcription algorithms described herein and transmitted to the other party.

Additional embodiments may include the implementation of the proposed speech-to-text algorithm in instant messaging applications, emails and chats. Integrating the speech-to-text conversion according to the disclosed algorithm into such application would allow users to enjoy a highly communicable interface to text-based applications. In all of the above mentioned embodiments the speech-to-text conversion component may be implemented in the end device of the user or in any other point in the network, such as on the server, the gateway and the like.

Reference is now made to FIG. 3C, there can be seen another system 360 for web based data mining, in accordance with an embodiment of the present invention.

Corpus of audio 362 in server 364 e.g. recorded radio programs or TV broadcast programs converted to text 366 creating text corpus 370 in server 368 according to the present invention.

Web user e.g. 378, 380 can connect to the website 374 to search for a program containing user search keywords e.g. name of a very rare flower. The server 376 can retrieve all the programs that contain the user keywords as short text e.g. program name, broadcast date and partial text containing the user keywords. The user 378 can then decide to continue search with additional keywords or to retrieve the full text of the program from the text corpus 370 or to retrieve the original partial or full audio program from the audio corpus 362.

The disclosed speech-to-text (STT) algorithm improves such data mining applications in non-transcribed programs (the spoken words are not available as a text):
a) More accurate STT 366 (more detected words)
b) The transcribed text may contain undetected words such as the Latin name of a rare flower (the proposed invention may create the rare flower name and user search keyword containing this rare flower name will be found in 360)
The user may want to retrieve the text from 360. In this case the proposed invention will bring all the text as detected words combined with undetected words presented as meaningless words and syllables with vowel anchors that are more readable then any prior art.

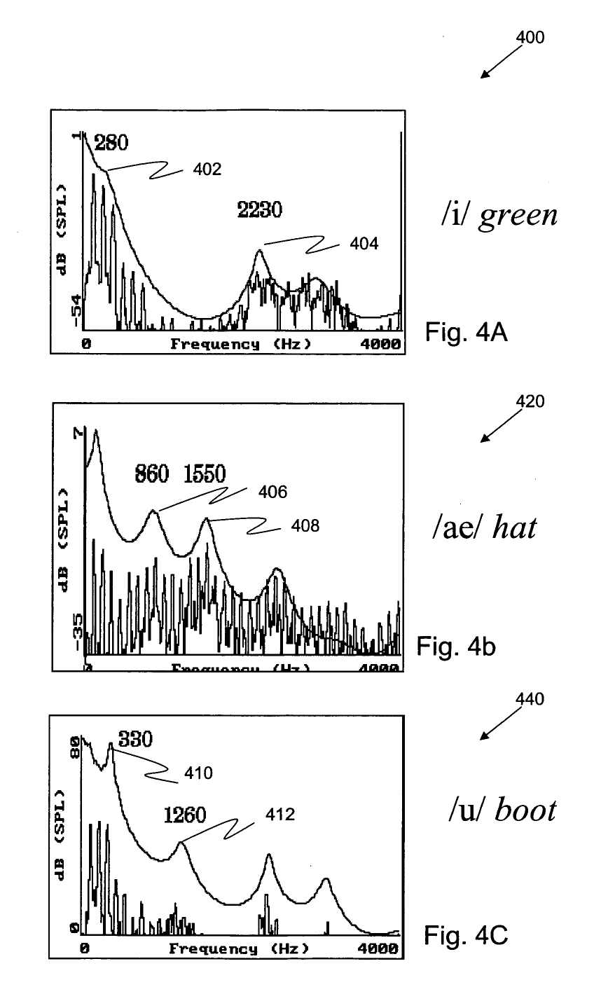

The published methods as described hereinbelow in FIGS. 4-6 and 9 may be coupled with the current invention methods to provide a very accurate method for speech to text conversion, as is further discussed with respect to FIGS. 7-12 hereinbelow.

Reference is now made to FIGS. 4A-4C, which are prior art spectrogram graphs 400, 420, 440 of experimental results for identifying vowel formants, (4A, /i/green, 4B /ae/hat and 4C /u/boot), in accordance with an embodiment of the present invention.

FIGS. 4A-4C represent the mapping of the vowels in two-dimensional frequency vs frequency gain. As can be seen from these figures, each vowel provides different frequency maxima peaks representing the formants of the vowel, called F1 for the first maximum, F2 for the second maximum and so on. The vowel formants may be used to identify and distinguish between the vowels. The first two formants F1, F2 of the “ee” sound (represented as vowel “i”) in “green” are F1, F2 (402, 404 at 280 and 2230 Hz respectively.

The first two formants 406, 408 of “a” (represented as vowel “ae”) in “hat” appear at 860 and 1550 Hz respectively.

The first two formants 410, 412 of “oo” (represented as vowel “u”) in “boot” appear at 330 and 1260 Hz respectively.

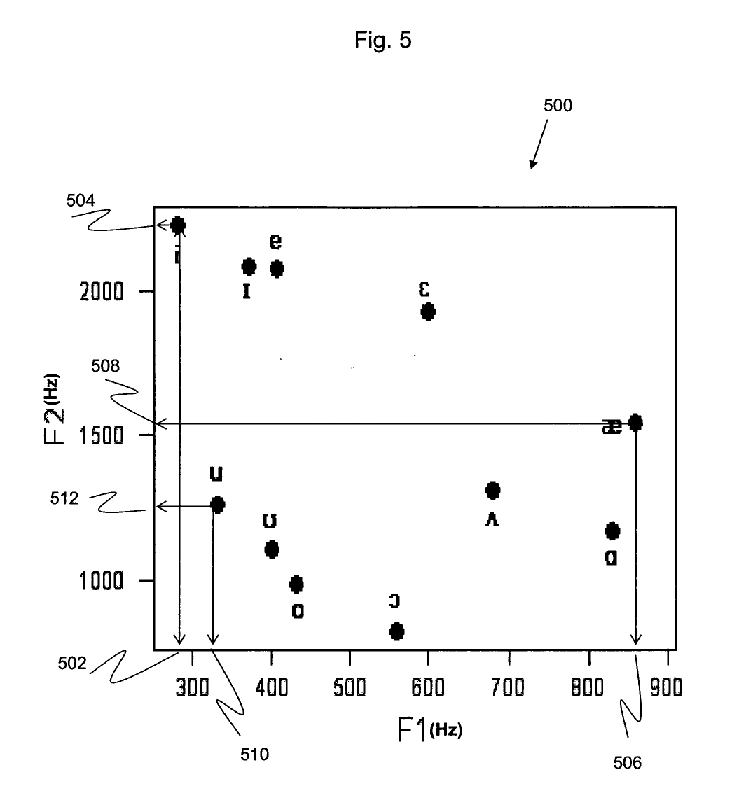

Two dimensional maps of the first two formants of a plurality of vowels appear in FIG. 5. The space surrounding each vowel may be mapped and used for automatic vowel detection. This prior art method is inferior to the method proposed by this invention.

FIG. 5 is a graph 500 showing a prior art method for mapping vowels according to maxima of two predominant formants F1 and F2 of each different vowel.

As can be seen in FIG. 5, the formants F1 and F2 of different vowels, fall into different areas or regions of this two-dimensional map e.g. vowel /u/ is presented by the formants F1 510 and F2 512 in the map 500.

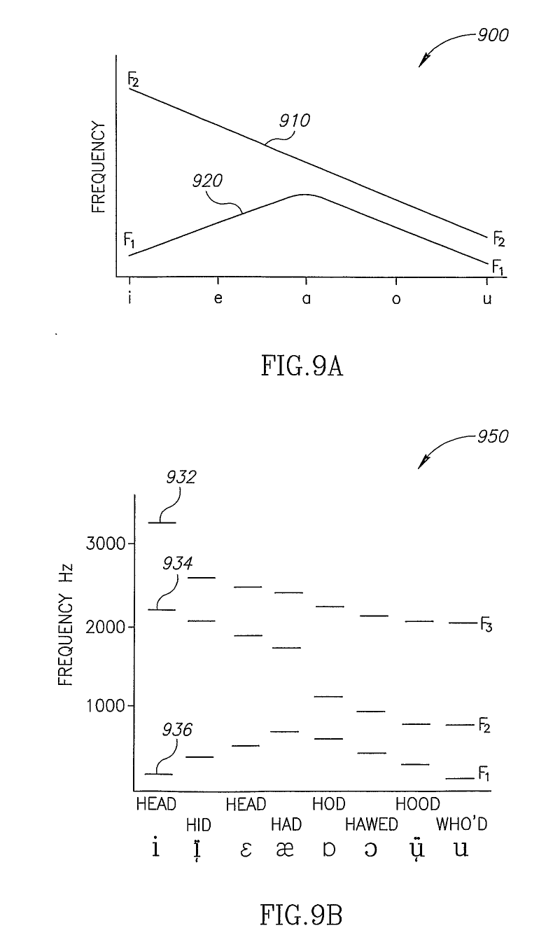

It should be understood that vowels in English may be represented as single letter representations per FIG. 5. These letters may be in English, Greek or any other language. Alternatively, as double letter vowel representations, such as “ea”, “oo” and “aw” as are commonly used in the English language. For example, in FIG. 4C, the “oo” of “boot” appears as “u”. In FIG. 9B, “ea” in the word “head” is represented as “ε”, but could alternatively, be represented as “ea”.

FIG. 5 is a kind of theoretical sketch that show the possibility to differentiate between the various vowels when using F1 and F2 formants.

It should be further understood that for every user, the formants of a certain vowel may fall in the two-dimensional map at different locations and having different relative distances between them.

Prof' Vytautas from Lithuania University demonstrated that it is possible to achieve more than 98% vowels detection accuracy for spontaneous users uttering single vowel in lab environment [ANALYSIS OF VOCAL PHONEMES AND FRICATIVE CONSONANT DISCRIMINATION BASED ON PHONETIC ACOUSTICS FEATURES”, ISSN 1392-124X INFORMATION TECHNOLOGY AND CONTROL, 2005, Vol. 34, No. 3, K [symbol] stutis Driaunys, Vytautas Rud\check{z}ionis, Pranas \check{Z}vinys].

However, the vowel detection accuracy drops dramatically, when vowels are within words since the vowel formants change and depend upon the consonants therebefore and thereafter. This may be explained by the fact that when a person speaks, his jaw frame and the entire vocal system is prepared prior to the verbalization of a next consonant in a way which is different from that when he is to verbalize a single vowel, which is not connected to various consonants.

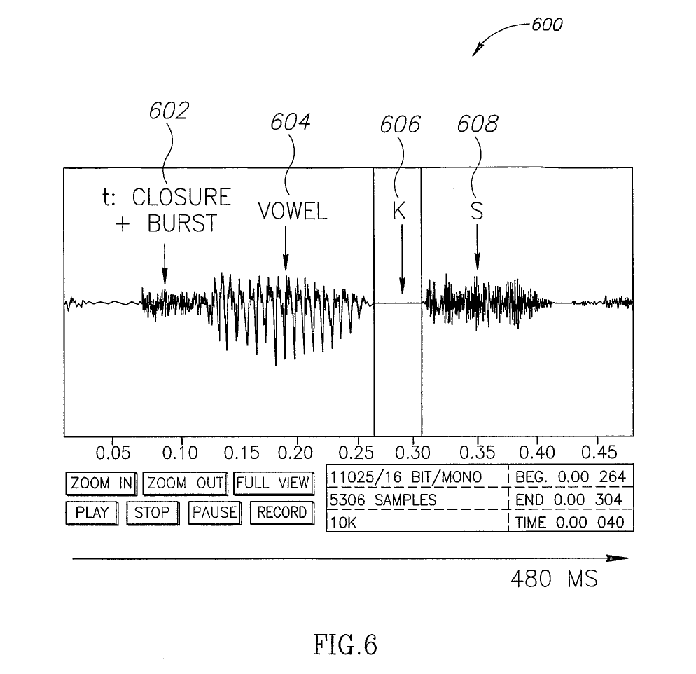

Reference is now made to FIG. 6, which is a graph 600 of user sampled speech (dB) over time, in accordance with an embodiment of the present invention.

Graph 600 represents user-sampled speech of the word ‘text’. The low frequency of the vowel /e/ that represents the user's mouth/nose vocal characteristics is well seen after the first ‘t’ consonant.

FIG. 9A is a graphical representation of theoretical representation of curves 900 of formants on frequency versus vowels axes.

A first curve 920 shows the axis of frequencies vs the vowels axis i, e, a, o, and u for the first formant F1. A second formant curve 910 shows the axis of frequencies vs the vowels axis for the second formant F2. The frequency is typically measured in Hertz (Hz).

The vowel formants curves demonstrate common behavior for all users, as is depicted in FIG. 9A. The main differences for each user are the specific formants frequencies and the curves scale e.g. children and women frequencies are higher then men frequencies. This phenomenon allows for the extrapolation of all missing vowels for each individual user e.g. if the vowel formants of the vowel ‘ea’ as in the word ‘head’ in 950 is not known and the case when all the other vowel formants are known then the curves of F1, F2 and F3 can be extrapolated and the formants of the vowel ‘ea’ can be determined on the extrapolated line.

User reference vowels are tailored to each new spontaneous user during its speech based on the following facts:
a) The number of possible vowels is very small (e.g. 11 English vowels as in FIG. 5).
b) Vowels appear in nearly every pronounced syllable. More specifically, every word consists of one or more syllables. Most syllables start with a consonant followed by a vowel and optionally end with stop consonant. Thus, even in a small sample of user sampled speech some vowels may appear more than once.

It will be described hereinafter how prior art transcription engine CSR can helps to identify the vowel formants of specific user in successfully detected words.

FIG. 9B is a graphical representation 950 of experimentally determined values of formants on frequency versus vowels axis for specific user, in accordance with an embodiment of the present invention.

FIG. 9B represents real curves of the F1, F2 and F3 formants in the Frequency vs Vowels axis for a specific user. The user pronounced specific words (hid, head, hood, etc.) and a first formant F1 936, a second formant F2 934 and a third formant F3 932 is determined for each spoken vowel.

FIG. 7 is a simplified flow chart 700 of method for converting speech to text, in accordance with an embodiment of the present invention.

In a sampling step 710, a sample of a specific user's speech is sampled.

The sampled speech is transferred to a transcription engine 720 which provides an output 730 of detected words, having a confidence level of detection of equal to or more than a defined threshold level (such as 95%). Some words remain undetected either due to a low confidence level of less than the threshold value or due to the word not being recognized at all.

In one example of a sentence comprising 12 words, it may be that word 3 and word 10 are not detected (e.g. detection below confidence level).

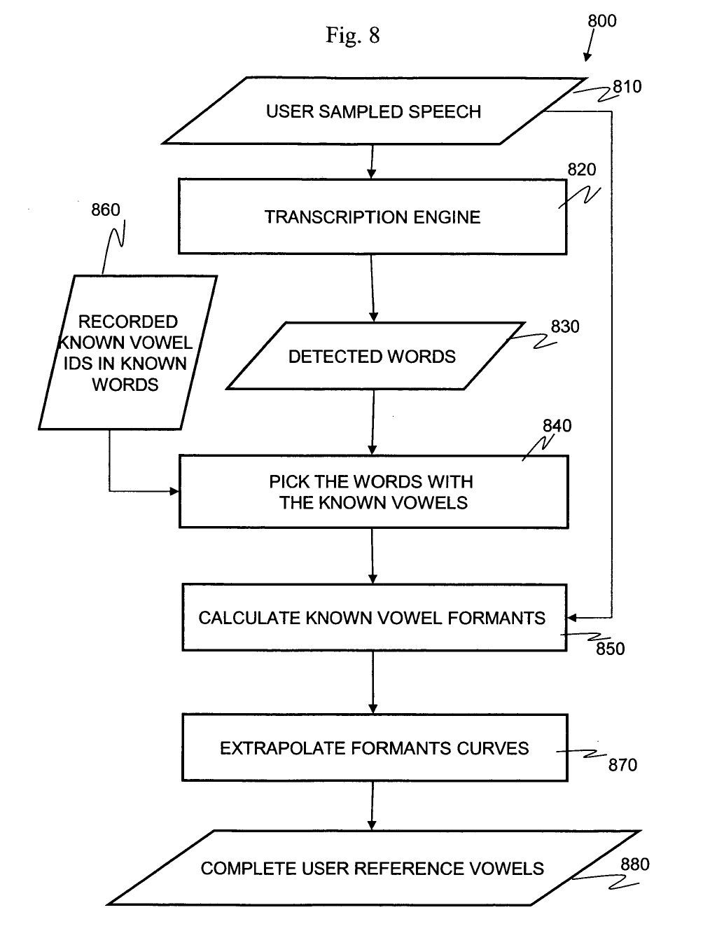

In a reference vowel calculation step 740, the detected words from output 730 are used to calculate reference vowel formants for that specific user. More details of this step are provided in FIG. 8. After step 740 each one of the vowels has its formants F1 and F2 tailored to the specific user 710.

In a vowel detection step 750, the vowels of the undetected words from step 730 are detected according to the distance of its calculated formants (F1 and F2) from the reference values from step 740 e.g. if the formants (F1,F2) of the reference vowel /u/ are (325, 1250) Hz, then if in the undetected word 3 in step 740 the calculated vowel formants are (327, 1247) Hz very close to that of the reference vowel /u/ (325, 1250) Hz and the distance to the other vowel formants is high then the detected vowel in the undetected word 3 will be /u/.

In a creating syllable step 760, syllables of the undetected words from step 730 are created, by linking at least one detected consonant and at least one detected vowel from step 750. For example, in an undetected word “eks arm pul” in 730, the vowel “e” may be accurately detected in step 750 and linked to the consonants “ks” to form a syllable “eks”, wherein the vowel “e” is used as a vowel anchor. The same process may be repeated to form an undetected set of syllables “eks arm pul” (example). In addition, the consonant time duration can be taken into account when deciding to which vowel (before or after) to link it e.g. short consonant duration tend to be the tail of previous syllable while long one tend to be the head of the next syllable. Example: the word ‘instinct’ comprises from two vowels ‘i’ that will produce two syllables (one for each vowel). The duration of the consonant ‘s’ is short resulting with the first syllables ‘ins’ with the consonant ‘s’ as a tail and second syllable ‘tinkt’.

Complex vowel comprising from two or more successive vowels as in the cat yowl ‘myau’ the vowel ‘a’ followed by the vowel ‘u’ will be presented as joined vowels. Example: the word ‘allows’ comprises from the vowel ‘a’ and complex vowel ‘ou’ resulting with two syllables ‘a’ and ‘low’ (or phonetic word ‘alous’ that can be corrected by the phonology orthography rules to ‘alows’ or ‘allows’. The ‘alows’ can be further corrected by speller to ‘allows’).

In a presenting step 770, the results comprising the detected words and the undetected words are presented. Thus a sentence may read “In this eks arm pul (word 3), the data may be mined using another “en gin” (word 10)”. According to one embodiment, the human end user may be presented with the separate syllables “eks arm pul”. According to some other embodiments, particularly with respect to data mining applications, the whole words or expected words may be presented as “exsarmpul” and “engin”. A spell-checker may be used and may identify “engin” as “engine”.

Each syllable or the whole word “exs arm pul” may be further processed with the phonology-aurtography rules to transcribe it correctly. Thereafter, a spell-checker may check edit distance to try and find an existing word. If no correction is made to “exsarmpul”, then a new word, “exsarmpul” is created which can be used for data mining.

The sentence may be further manipulated using other methods as described in Shpigel, WO2006070373.

It should be noted that the method proposed may introduce some delay to the output words in step 770, in cases where future spoken words (e.g. word 12) are used to calculate the user reference vowels that are used to detect previous words (e.g. word 3). This is true only for the first words batch where not all the user reference vowels are ready yet from step 740. This drawback is less noticeable in transcription applications that are more similar to half-way conversations (wherein only one person speaks at the same time). It should be noted that there are 11 effective vowels in the English language, which is less than the number of consonants. Normally, every word in the English language comprises at least one vowel.

User reference vowels can be fine-tuned continuously by any new detected word or any new detected vowel from the same user by using continuous adaptation algorithms that are well known in prior art.

Reference is now made to FIG. 8, which is a simplified flow chart 800 of method for calculating user reference vowels based on the vowels extracted from known words, in accordance with an embodiment of the present invention.

Multiple words with their known vowel identifications (IDs) are recorded offline to provide an output database 860. For example, the word ‘boot’ contains the vowel ID /u/. If the word ‘boot’ accompanied by its vowel ID /u/ is presented in the database 860, then whenever the word ‘boot’ is detected in the transcription step 820, then the formants F1, F2 of the vowel /u/ for this user can be calculated and then used as a reference formants to detect the vowel /u/ in any future received words containing the vowel /u/ said by this user e.g. ‘food’.

It should be noted that it is assumed that database 860 contains the most frequently used words in a regular speech application.

User sampled speech 810 enters the transcription step 820, and an output 830 of detected words is outputted.

Detected words with the known vowel IDs (860) are selected in a selection step 840.

In a calculation step 850, the input sampled speech 810 of a vowel duration is processed with frequency transform (e.g. FFT) resulting with frequency maxima F1 and F2 for each known vowel from step 840 as depicted in FIG. 4.

Reference vowel formants are not limited to F1 and F2. In some cases additional formants (e.g. F3) can be used to identify vowel more accurately.

Each calculated vowel in step 850 has a quantitative value of F1, F2, which varies from user to user, and also varies slightly per user according to the context of that vowel (between two consonants, adjacent to one consonant, consonant-free) and other variation known in prior art e.g. speech intonation. Thus, upon mapping one vowel for a specific user in a large quantity of speech, the values of F1, F2 for this vowel can change within certain limits. This will provide a plurality of samples for each formant F1, F2 for each vowel, but not necessarily all the vowels in the vowel set. In other words, step 850 generates a personalized multiple data points for each calculated formant F1,F2 from the known vowels which are unique for a specific user.

In an extrapolation step 870, line extrapolation method is applied to the partial or full set of personalized detected vowel formant data points from 850 to generate the formant curves as in FIG. 9A that will be used to extract the complete set of personalized user reference vowels 880. In other words, the input to the line extrapolation 870 may contain more than one detected data point on graph 910, 920 for each vowel and data points for some other vowels may be missing (not all the vowels are verbalized). The multiple formant data points of the existing vowels are extrapolated in step 870 to generate single set of formants (F1, F2) for each vowel (including formants for the missing vowels).

The line extrapolation in step 870 can be any prior art line extrapolation method from any order (e,g, order 2 or 3) used to calculate the best line curve for given input data points as the curves depicted in FIG. 9A 910, 920.

This method may be used over time. As a database of the vowel formants of a particular user increases over time, the accuracy of an extrapolation of a formant curve will tend to increase because more data points become available. Adaptive prior art methods can be used to update the curve when additional data points are available to reduce the required processing resources, compared to the case when calculation is done from the beginning for each new data point.

The output of step 870 may be a complete set of personalized user reference vowels 880. This output may be used to detect vowels of the residual undetected words in 750 FIG. 7.

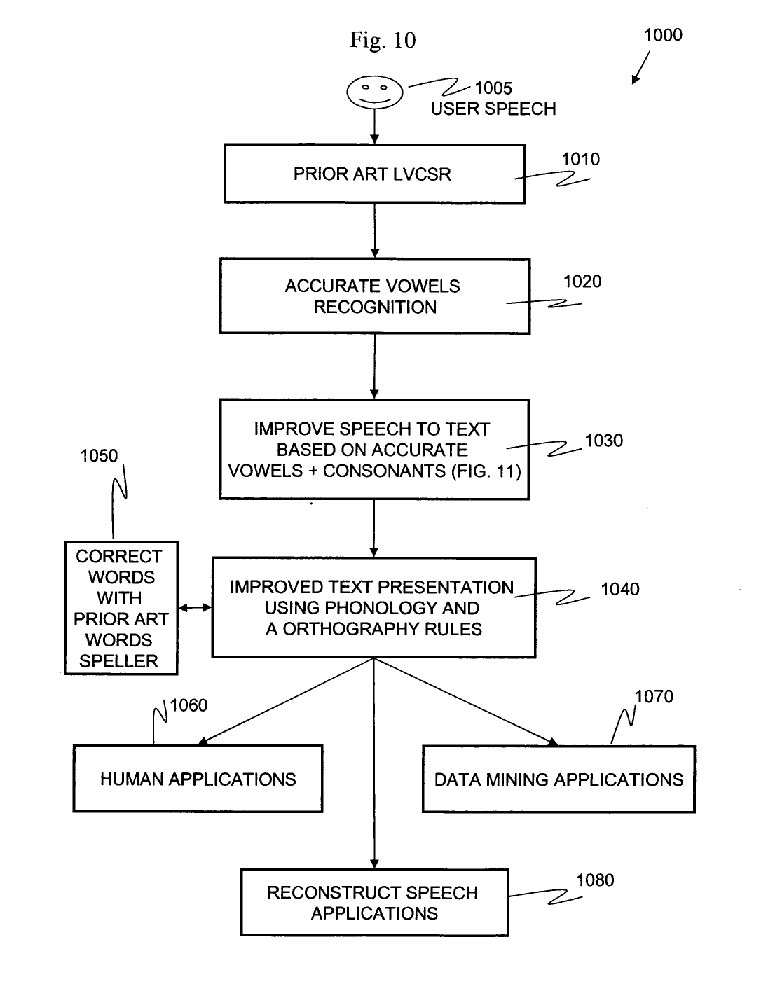

FIG. 10 is a simplified flow chart 1000 of a method for transforming spontaneous user speech to possible applications, in accordance with an embodiment of the present invention.

Spontaneous user speech 1005 is inputted into a prior art LVCSR engine 1010. It is assumed that only 70-80% words are detected (meet a threshold confidence level requirement). The vowels recognition core technology described hereinabove with respect to FIGS. 7-9 for accurately detecting vowels in a detection step 1020.

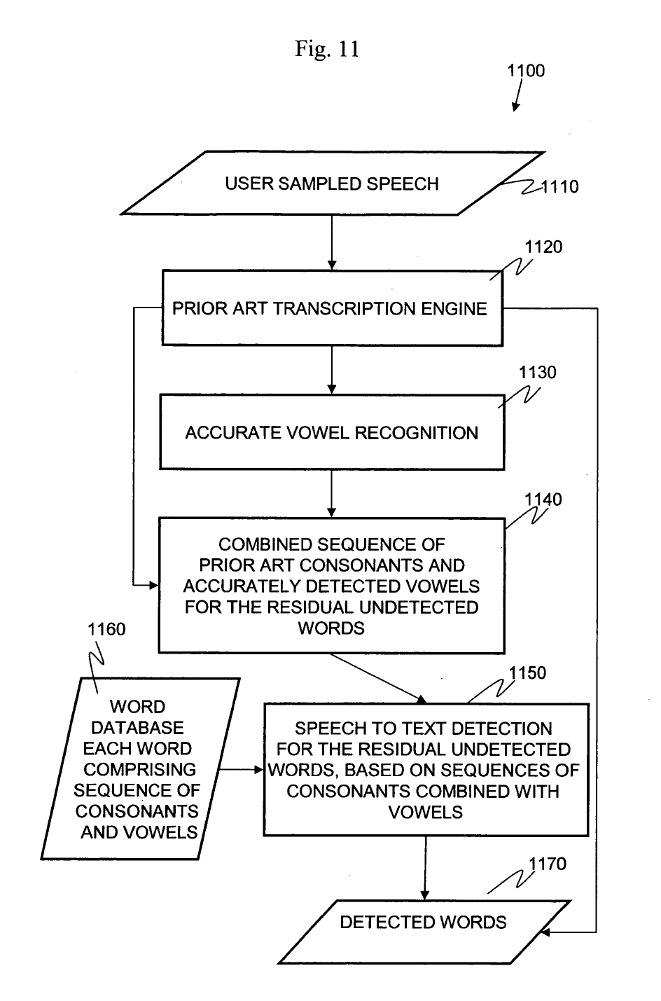

In a further detection step 1030, the accurately detected vowels, using the methods of the present invention, are used together with detected prior art consonants to detect more words from the residual undetected 20-30% of words from step 1010, wherein each word is presented by a sequence of consonants and vowels. More details of this step are provided in FIG. 11.

Phonology and orthography rules are applied to the residual undetected words in step 1040. This step may be further coupled with a spell-checking step 1050. The text may then be further corrected using these phonology and orthography rules. These rules take into account the gap between how we hear phonemes and how they are written as part of words. For example, ‘ol’ and ‘all’. A prior art spell-checker 1050 may be used to try to find additional dictionary words when a difference (edit distance) between the corrected word and a dictionary word is small. The output of steps 1130 and 1040 is expected to detect up to 50% of the undetected words from step 1010. These values are expected to change according to the device and recording method and prior art LVCSR method used in step 1010.

Applications of the methods of the present invention are exemplified in Table 1, but are not limited thereto, and are further discussed hereinbelow.

The combined text of detected words and the undetected words can be used for human applications 1060 where the human user will complete the understanding of the undetected words presented as a sequence of consonants and vowels and/or grouped in syllables based on vowel anchors.

The combined text can be used also as search keywords for data mining applications 1070 assuming that each undetected word may be a true word that is missing in the STT words DB, such as words that are part of professional terminology or jargon.

The combined text may be used in an application step for speech reconstruction 1080. Text outputted from step 1040 may be converted back into speech using text to speech engines known in the art. This application may be faster and more reliable than prior art methods as the accurately detected vowels are combined with consonants to form syllables. These syllables are more natural to be pronounced as part of a word than the prior art mixed display methods (U.S. Pat. No. 6,785,650 to Basson, et al.).

Another method to obtain the missing vowels for the line extrapolation in 870 is by asking the user to utter all the missing vowels /a/, /e/, . . . e.g. “please utter the vowel /o/” or by asking the user to say some predefined known words that contain the missing vowels e.g. anti /a/, two /u/, three /i/, on /o/, seven /e/, etc.

It should be noted that this can be performed once for every new user and saved for future usage for the same user.

The method of asking the user to say specific words or vowels is inferior in quality to cases in which the user reference vowels are calculated automatically from the natural speech without the user intervention.

The phonology and orthography rules 1040 are herein further detailed. Vowels in some words are written differently from the way in which they are heard, for example the correct spelling of the detected word ‘ol’ is ‘all’. A set of phonology and orthography rules may be used to correctly spell phoneme in words. An ambiguity (more then one result) is possible in some of the cases.

Example for such rules for the ‘ol’ (vowel ‘o’ followed by the consonant ‘L’). In the following words the vowel ‘o’ is written sometime with the letter ‘a’.

All, [ball, boll], [call, calling, cold, collecter], doll, [fall, foll], [gall, gol], [hall, holiday], loll, [mall, moll], [pall, poll], [rail, roll], sol, [tall, toll], wall.

TABLE 2
Example of Phonology and Orthography Rules

| Basic rule | Sub rule | Presentation rule |
|---|---|---|
| Vowel ‘o’ is | Any syllable started with the vowel | All, Always, |
| followed by the | ‘o’ | Although |
| consonant ‘L’ | | |
| | The syllable is ended with | Cold |
| | additional consonant differ then ‘L” | |
| | The next syllable (cal-ling) | Calling, |
| | includes the vowel ‘i’ | |
| | Other | Cold, Cocktail, |
| | | color, |

Human applications 1060 are herein further detailed. Applications where all the user speech is translated to text and presented to the human user e.g. when customer is calling to a call center, the customer speech is translated to text and presented to human end user. See Table 1 and WO2006070373 for more human applications.

In this invention, the end user is presented with the combined text of detected words and the undetected words presented as a sequence of syllables with vowel anchors.

### Example

“all i know”—original user speech intention 1005
“ol i no”—phonemes presentation after step 1030
“all i no”—phonology/orthography rules used to correct ‘ol’ to ‘all’ 1040 (assuming that “no” and “know” is ambiguity that 1040 can't solve).
“all I know”—using prior art ambiguity solver that take into account the sentence content.

Data mining applications 1070 are herein further detailed. DM applications are a kind of search engine that uses input keywords to search for appropriate content in DB. DM is used for example in call centers to prepare in advance content according to the customer speech translated to text. The found content is displayed to the service representative (SR) prior to the call connection. In other words, the relevant information of the caller is displayed to the SR in advance before handling the call, saving the time of the SR to retrieve the content when starting to speak with the customer.

The contribution of this invention to DM applications:
a. The additional detected words increase the number of possible keywords for the DM searching.
b. The creation of words, as proposed in 1040, adds more special keywords presenting unique names that were not found in the DB but are important for the search e.g. special drug name/notation

Reference is now made to FIG. 11, which is a graph 1100 of a simplified method for detection of words from the residual undetected prior art speech to text, in accordance with an embodiment of the present invention.

In a sampling step 1110, a sample of a specific user's speech is sampled.

The sampled speech is transferred to a prior art transcription engine 1120 which provides an output of detected words and residual undetected words. Accurate vowel recognition is performed in step 1130 (per method in FIG. 7 steps 740-750). In step 1140 each of the residual undetected words is presented as a sequence of prior art detected consonants combined with the accurate detected vowels from step 1130. In step 1150 a speech to text (STT) is performed based on the input sequences of consonants combined with the vowels in the correct order. The STT in step 1150 uses a large DB of words each presented as a sequence of consonants and vowels 1160. A word is detected if the confidence level is above predefined threshold. Step 1170 comprising the detected words from step 1120 combined with the additional detected words from step 1170 and combined with the residual undetected words.

Different scoring value can be applied to step 1150 according to the following criteria:
a) Accuracy of detection e.g. detected vowel will get higher score then detected consonant.
b) Time duration of consonant or vowel e.g. when the vowel duration is more then the consonant duration (vowel ‘e’ in the word ‘text’ in FIG. 6) or when specific consonant duration is very small compared to the others (the last consonant ‘t’ in the word ‘text’ in FIG. 6).

Example: suppose we have the sequence of consonants and vowels of the said word ‘totem pole’. The sequence consonants and vowels representing the ‘totem pole’ are T,o,T,e,M, P,o,L (the vowels are in small letters). Suppose that the sequence of T,o,T,e,M,P,o,L is one of the words in 1160. Any time this sequence is provided to 1150 from 1140 then the word ‘totempol’ will be detected and added to the detected words 1170. For the sequence T,o,T,e,N,P,o,L (error detection of the consonant M as N) provided by 1140, the edit distance to T,o,T,e,M,P,o,L is low resulting with correct detection of the word ‘totempol’. Undetected result may be further manipulated after step 1150 by phonology orthography rules and spell-checker (per method in FIG. 10 steps 1040-1050), which may output “totem pole” as a final result.

The DB of words 1160 may contain a sequence of combined consonant and vowels. The DB may contain syllables e.g. ‘ToT’ and ‘PoL’ or combined consonants, vowels and syllables to improve the STT search processing time.

Some aspects of the present invention are directed to a method to separate the LVCSR tasks between the client and the server according to the following guidelines:

LVCSR client side—minimizing the computational load and memory and minimizing the client output bit rate.

LVCSR server side—completing the LVCSR transcription with adequate memory and processing resources.

Reference is now made to FIG. 12, which is a simplified flow chart 1200 illustrating one embodiment of a method for partitioning speech to text conversion, in accordance with an embodiment of the present invention.

FIG. 12 represents the concept of partitioning the LVCSR tasks between the client source device and a server.

In a voice provision step 1210, a user speaks into a device such as, but not limited to, a cellular phone, a landline phone, a microphone, a personal assistant or any other suitable device with a recording apparatus. Voice may typically be communicated via a communication link at a data rate of 30 Mbytes/hour.

In a voice pre-processing step 1220, the user voice is sampled and pre-processed at the client side 1220. The pre-process tasks include the processing of the raw sampled speech by FFT (Fast Fourier Transform) or by similar technologies to extract the formant frequencies, the vowels formants, time tags of element, etc. The output of this step is frequency data at a rate of around 220 kbytes/hr. This provides a significant saving in the communication bit rate and/or bandwidth required to transfer the pre-processed output, relative to transferring sampled voice (per step 1210).

It should be understood that this step utilizes data of frequency measured for many voice samples. There are thus many measurements of gain (dB) versus frequency for each letter formant. Curve maxima are taken from the many measurements to define the formants for each letter (vowels and consonants).

In a transferring step 1230, the pre-processed output is transferred to the server via a communication link 1230 e.g. WAP. In a post-processing step 1240, the pre-processed data is post-processed. Thereafter, in a post-processed data conversion step 1250, a server for example may complete the LVCSR process resulting in a transcribed text. In some cases steps 1240-1250 may be performed in one step. It should be understood that there may be many variations on this method, all of which are construed to be within the scope of the present invention. The text is typically transferred at a rate of around 22 kbytes/hr.

Finally, in a text transferring step 1260, the transcribed text is transferred from the server to the recipient.

The method described divides up the LVCSR tasks between the client and the server sides. The client/source device processes the user input sampled speech to reduce its bit rate. The client device transfers the preprocessed results to a server via a communication link to complete the LVCSR process.

The client device applies minimal basic algorithms that relate to the sampled speech e.g. searching the boundaries and time tag of each uttered speech (phone, consonant, vowel, etc.), transforming each uttered sound to the frequency domain using the well known transform algorithms (such as FFT).

In other words, the sampled speech is not transferred to the server side such that all the algorithms that are applied to the input sampled speech are performed at the server side.

The communication link may be a link between the client and a server. For example, a client cellular phone communicates with the server side via IP-based air protocols (such as WAP), which are available on cellular phones.

The server can be located anywhere in a network holds the remainder of LVCSR heavy algorithms as well as huge words vocabulary database. These are used to complete the transcription of the pre-processed data that was partially pre-processed at the client side. The transcription algorithms may also include add-on algorithms to present the undetected words by syllables with vowel anchors as proposed by Shpigel in WO2006070373.

The server may comprise Large Vocabulary Conversational Speech Recognition software (see for example, A. Stolcke et al. (2001), The SRI March 2001 Hub-5 Conversational Speech Transcription System. Presentation at the NIST Large Vocabulary Conversational Speech Recognition Workshop, Linthicum Heights, Md., May 3, 2001; and M Finke et al., “Speaking Mode Dependent Pronunciation Modeling in Large Vocabulary Conversational Speech Recognition,” Proceedings of Eurospeech '97, Rhodos, Greece, 1997 and M. Finke, “Flexible Transcription Alignment,” 1997 IEEE Workshop on Speech Recognition and Understanding, Santa Barbara, Calif., 1997, the disclosures of which are herein incorporated by reference). The LVCSR software may be applied at the server in an LVCSR application step 1250 to the sound/voice recorded to convert it into text. This step typically has an accuracy of 70-80% using prior art LVCSR.

LVCSR is a transcription engine for the conversion of spontaneous user speech to text. LVCSR computational load and memory is very high.

The transcribed text on the server side can be utilized by various applications e.g. sending back the text to the client immediately (a kind of real time transcription), saved and retrieved later by the user using existing internet tools like email, etc.

TABLE 3
Approximation for bits rate calculation for 1 hour transcription:

| Bit source | Bits rate | Bytes rate | Comment |
|---|---|---|---|
| Raw | ~230 M | ~30 MBytes | For example 64,000 bits/ |
| sampled | bits | | sec × 3600 sec |
| speech | | | (step 1210, FIG. 12) |
| Text | ~180 K | ~22 KBytes | Speech of 1 sec may contain |
| | bits | | 2 words each contain 5 |
| | | | characters and each character |
| | | | presented by 5 bits (step 1250, |
| | | | FIG. 12) |
| LVCSR | ~1800 K | ~220 KBbytes | The client output is text |
| client | bits | | compression multiplied by 10 |
| output | | | to present real numbers like |
| | | | the FFT output |
| | | | (step 1220, FIG. 12) |

The table shows that the client output bit rate is reasonable to manage and transfer via limited communication link like cellular IP WAP.

Various LVCSR modes of operation may dictate different solutions to reduce the client computational load and memory and to reduce the communication link bit rate.

### Advantages of the Present Invention

a. Improve vastly the vowels recognition accuracy tailored for each new spontaneous user without using predefined known training sequence and without using vowels corpora of various user types.
b. Improving words detection accuracy in existing speech recognition engines
c. Phonology and orthography rules used to spell correctly incoming phoneme's words.
d. Speech to text solution for human applications—a method to present all the detected and undetected words to the user
e. Speech to text solution for DM applications—improve words detection accuracy and creating additional unique search keywords.

While the above example contains some rules, these should not be construed as limitations on the scope of the invention, but rather as exemplifications of the preferred embodiments. Those skilled in the art will envision other possible variations of rules that are within its scope.

### LIST OF DEFINITIONS (IN ALPHABETIC ORDER)

Edit distance—the edit distance between two strings of characters is the number of operations required to transform one of them into the other.

Formant—the mouth/nose acts as an echo chamber, enhancing those harmonics that resonate there. These resonances are called formants. The first 2 formants are especially important in characterizing particular vowels.

Line extrapolation—a well known prior art methods to find the best curve that fit multiple dots e.g. second or third order line extrapolation.

Sounded vowels—vowels that represent the sound e.g. the sounded vowel of the word ‘all’ is ‘o’

Phonemes A phoneme is one of a small set of speech sounds that are distinguished by the speakers of a particular language.

Stop consonant—consonant at the end of the syllable e.g. b, d, g . . . p, t, k

Transcription engine—CSR (or LVCSR) that translates all the input speech words to text. Some transcription engines for spontaneous users are available by commercial companies like IBM, SRI and SAILLABS. Transcription has sometimes other names e.g. dictation.

User—in this doc the user is the person that his sampled speech is used to detect vowels.

User reference vowels—the vowel formants that are tailored to a specific user and are used to detect the unknown vowels in the user sampled speech e.g. new vowel is detected according to its minimum distance to one of the reference vowels.

User sampled speech—input speech from user that was sampled and available to digital processing e.g. calculating the input speech consonants and formants. Note: also each sampled speech relates to a single user, the speech source may contain more then one user's speech. In this case an appropriate filter that is well know in prior art must be used to separate the speech of each user.

Various user types—users with different vocal characteristics, different user types (men, women, children, etc.), different languages and other differences known in prior art.

Vowels—{/a/, /e/, /i/, /u/, /o/, /ae/, . . . } e.g. FIG. 2. Note: different languishes may have different vowels set. Complex vowels are a sequence of vowels (2 or more) one after the other e.g. the cat yowl MYAU comprising a sequence of the vowels a and u.

Vowel formants map—the location of the vowel formants as depicted in FIG. 4 for F1 and F2. The vowel formants can be presented in curves as depicted in FIG. 6. The formants location is differ for various user types.

Note: also F1 and F2 are the most important to identify vowel, higher formants (e.g. F3) can also be taken into account to identify new vowels more accurately.

Word speller/spell checker—when a word is written badly (with errors) a speller can recommend a correct word according to minimal word distance.

### LIST OF ABBREVIATIONS

CSR Continues Speech Recognition
DB Data Base
DM Data Mining (searching content in DB according to predefined keywords)
IP Internet Protocol
FFT Fast Fourier Transforms
GSM Global System for Mobile
LVCSR Large Vocabulary Continuous Speech Recognition used for transcription applications and data mining.
PBX Public
PSTN Public Switching Telephone Network
SR Service Representative e.g. in call center
STT Speech-to-text
WAP Wireless Application Protocol

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

What is claimed is:

1. A method for accurate vowel detection in speech to text conversion, the method comprising the steps of:
a) applying a voice recognition algorithm to a first user speech input so as to detect known words and residual undetected words; and
b) detecting at least one undetected vowel from said residual undetected words by applying a user-fitted vowel recognition algorithm to vowels from said known words so as to accurately detect said vowels in said undetected words in said speech input.

2. A method according to claim 1, wherein said voice recognition algorithm is one of: Continuous Speech Recognition, Large Vocabulary Continuous Speech Recognition, Speech-To-Text, Spontaneous Speech Recognition and speech transcription.

3. A method according to claim 1, wherein said detecting vowels step comprises:
a) creating reference vowel formants from the detected known words;
b) comparing vowel formants of said undetected word to reference vowel formants; and
c) selecting at least one closest vowel to said reference vowel so as to detect said at least one undetected vowel.

4. A method according to claim 3, wherein said creating reference vowel formants step comprises:
a) calculating vowel formants from said detected known words;
b) extrapolating formant curves comprising data points for each of said calculated vowel formants; and
c) selecting representative formants for each vowel along the extrapolated curve.

5. A method according to claim 4, wherein the extrapolating step comprises performing curve fitting to said data points so as to obtain formant curves.

6. A method according to claim 4, wherein the extrapolating step comprises using an adaptive method to update the reference vowels formant curves for each new formant data point.

7. (canceled)

8. (canceled)

9. A method according to claim 1, further comprising creating syllables of said undetected words based on vowel anchors.

10. (canceled)

11. (canceled)

12. (canceled)

13. A method according to any of claims 1-12, further comprising, converting the user speech input into text.

14. A method according to claim 13, wherein said text comprises at least one of the following: detected words, syllables based on vowel anchors, and meaningless words.

15. A method according to claim 13, wherein said user speech input may be detected from any one or more of the following inputting sources: a microphone, a microphone in any telephone device, an online voice recording device, an offline voice repository, a recorded broadcast program, a recorded lecture, a recorded meeting, a recorded phone conversation, recorded speech, and multi-user speech.

16. (canceled)

17. A method according to claim 13, further comprising relaying of said text to a second user device selected from at least one of: a cellular phone, a line phone, an IP phone, an IP/PBX phone, a computer, a personal computer, a server, a digital text depository, and a computer file.

18. A method according to claim 17, wherein said relaying step is performed via at least one of: a cellular network, a PSTN network, a web network, a local network, an IP network, a low bit rate cellular protocol, a CDMA variation protocol, a WAP protocol, an email, an SMS, a disk-on-key, a file transfer media or combinations thereof.

19. (canceled)

20. A method according to claim 13, for use in transcribing at least one of an online meeting through cellular handsets, an online meeting through IP/PBX phones, an online phone conversation, offline recorded speech, and other recorded speech, into text.

21. (canceled)

22. (canceled)

23. (canceled)

24. A method according to any of claims 1-23, wherein said method is applied to an application selected from: transcription in cellular telephony, transcription in IP/PBX telephony, off-line transcription of speech, call center efficient handling of incoming calls, data mining of calls at call centers, data mining of voice or sound databases at internet websites, text beeper messaging, cellular phone hand-free SMS messaging, cellular phone hand-free email, low bit rate conversation, and in assisting disabled user communication.

25. A method according to any of claims 1-24, wherein said detecting step comprises representing a vowel as one of: a single letter representation and a double letter representation.

26. A method according to claim 1-24, wherein said creating syllables comprises the linking of consonant to anchor vowel as one of: tail of previous syllable or head on next syllable according to its duration.

27. A method according to claim 1-24, wherein said creating syllables comprising joined successive vowels in a single syllable.

28. (canceled)

29. A method for accurate vowel detection in speech to text conversion, substantially as shown in the figures.

30. A system for accurate vowel detection in speech to text conversion, substantially as shown in the figures.
